(19) United States
(12) Patent Application Publication
(10) Pub. No.: US 2024/0135328 A1
(43) Pub. Date: Apr. 25, 2024

(54) RECRUITER MARKETPLACE FOR ALL

(71) Applicant: Mofoluwaso KUTI, Gaithersburg, MD (US)

(72) Inventor: Mofoluwaso KUTI, Gaithersburg, MD (US)

(21) Appl. No.: 18/383,690

(22) Filed: Oct. 24, 2023

Related U.S. Application Data
(60) Provisional application No. 63/419,195, filed on Oct. 25, 2022.

(51) Int. Cl. G06Q 10/1053

(52) U.S. Cl. CPC G06Q 10/1053

(57) ABSTRACT

The invention includes systems and methods for the crowdsourcing job opportunities to a large, geographically unlimited user community in order. It includes platform that allows and empowers everyone to be a recruiter and exponentially increases the pool of candidates for job opportunities. Also, by linking this expanded pool of candidates to companies and corporate recruiters, the platform provides an enabling environment where they can find the right candidate. This invention empowers everyone to be a recruiter, using their personal position or network to find, draw and then push out candidates to companies and organizations searching. The invention leverages push notification technology to enable rapid interactions between companies and job seekers to fill positions. Current methods use recruiting entities to create static marketplaces where candidates can be found. With the present invention, each individual assumes the role of a recruiter, in finding jobs for themselves or for people in their network.

### CROSS-REFERENCE TO RELATED APPLICATIONS

This application claims the benefit of priority of U.S. Provisional Pat. App. Ser. No. 63/419,195, the contents of which are hereby incorporated by reference herein in their entirety.

### BACKGROUND OF THE INVENTION

There are many online platforms currently available for identifying employment candidates, submitting personal information and resumes in application for open positions, and receiving and analyzing submissions to determine qualifications. Current methods use recruiting entities to create static marketplaces where candidates can be found. For example, many platforms have subscribing companies post jobs openings for review by interested applicants. Individuals then post their resumes to be considered in filling positions of interest, but do not socialize or crowdsource opportunities so others might recommend people they know who did not necessarily see the postings. The invention of the present disclosure is intended to do just that, thereby expanding the pool of recruiters beyond the subscribing companies to include virtually anyone who might know a qualified candidate for a posted position.

### BRIEF SUMMARY OF THE INVENTION

The invention of the present disclosure enables everyone having access to a platform as described herein to assume the role of a recruiter, in finding jobs for themselves or for people in their network. They may then create a pool of candidates that can then be pushed out to companies seeking a particular type of service. The invention can be rolled out in a scalable way, by city, location, country and then worldwide with few boundaries.

The invention offers a better solution than current methods for searching for and recruiting talent. By creating a platform that allows and empowers everyone with access to be a recruiter, it exponentially increases the pool of candidates for positions and job seekers in general. Also, by linking this expanded pool of candidates to companies and corporate recruiters seeking qualified talent, the platform provides an enabling environment where they can find the right candidate using means beyond the mere posting of a position and waiting for candidates to apply.

This invention is unique because it allows and empowers everyone to be a recruiter, using their personal position or network to find, draw and then push out candidates to companies and organizations searching for people to fill open positions. It fundamentally differs from the use of corporate recruiters that have built extensive and expensive static frameworks that lack this utility. The invention of the present disclosure is seamless and easy to use, creating a pool of candidates using individuals to find qualified candidates and earn a fee.

Additionally, a feature of the invention of the present disclosure is a video editing and parsing process in the form of a downloadable software application, which can be used to build a video resume that allows a viewer of the video resume to navigate to particular sections of interest, such as education, experience, etc. In addition, full videos or segments thereof may be shared across departments within a hiring entity in order to facilitate the assessment of candidates for a given position. These and other benefits of the invention will be apparent to one of ordinary skill in the art in view of the disclosure that follows.

### BRIEF DESCRIPTION OF THE DRAWINGS

FIG. 1 illustrates a flow chart for executing a method according to the present invention, from posting an open position to scheduling and confirming an interview.

FIG. 2 illustrates use of a process according to the present disclosure for negotiating an employment offer, checking references, screening candidates, and releasing full offers.

FIG. 3 illustrates a process similar to that shown in FIG. 2, wherein a candidate rejects an offer, and a posting is released again.

FIG. 4 illustrates a process flow for disbursing payments to users of a system according to the present invention as compensation for recommending qualified candidates.

FIG. 5 illustrates an exemplary system architecture according to an embodiment of the present invention.

### DETAILED DESCRIPTION OF THE INVENTION

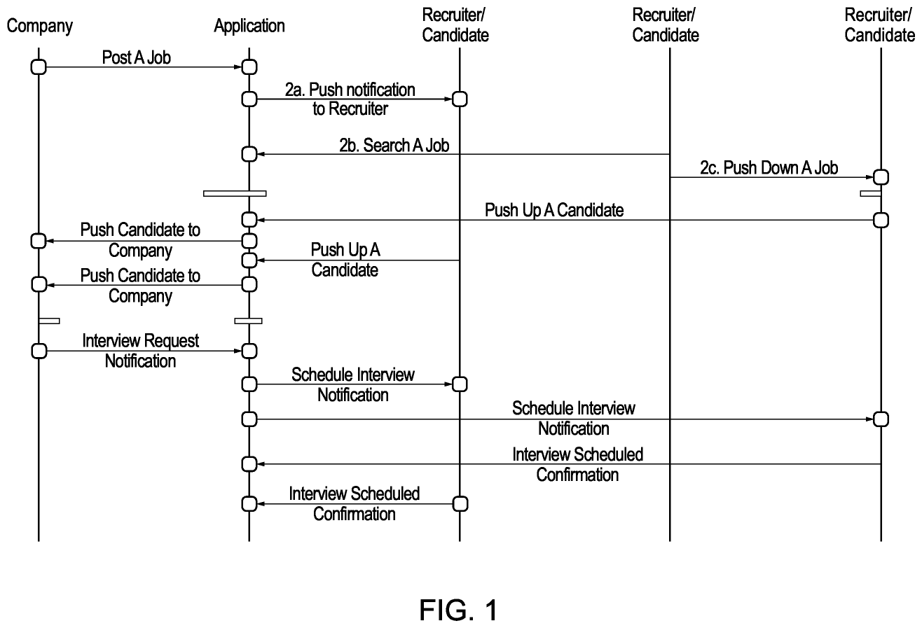

The invention of the present disclosure is best described with reference to the accompanying drawings. Beginning with FIG. 1, a process flow is illustrated wherein a job is posted, a candidate is presented by a recruiter, and an offer is ultimately made and accepted. First, a company with an open position posts the position using a software application according to the present disclosure, wherein a push notification is transmitted to a recruiter or candidate for the position. Notifications are pushed to recruiters and candidates alike, and either may push a notification to other recruiters and candidates, rapidly expanding knowledge of the open position among the community and qualified candidates. From within the community, a candidate may be identified and his or her information pushed up to the software application for processing.

If the candidate's qualifications are a match for the posting, the candidate's information is then pushed to the company that posted the position. If the company would like to schedule an interview with a particular candidate, an interview request notification is pushed down to the submitters and an interview schedule notification may also be included. This can then be confirmed by a selected candidate and the schedule confirmed.

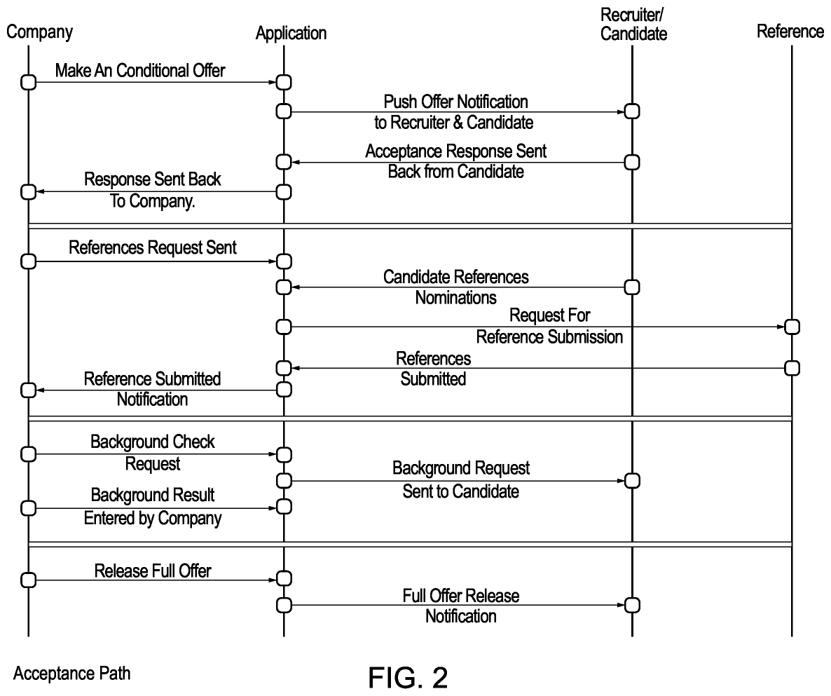

Turning now to FIG. 2, a conditional offer may be pushed down from the company to the software application, where it is processed and forwarded to the relevant recruiter and candidate, where the candidate may then accept a conditional offer. Conditions may include, for example, submission of references, background checks, and other information requirements common to human resources practices. Notifications of the requirements may be pushed to the candidates, who may then respond to the information requests. Finally, if all information requirements are satisfied, the company may release a full offer and push that down to the candidate of choice.

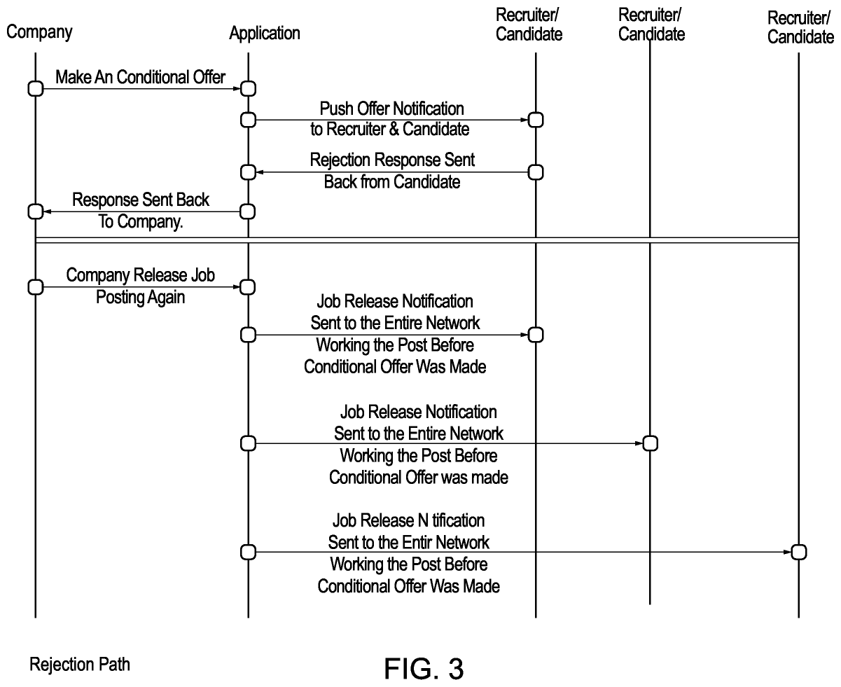

Conversely, a candidate may reject an offer, as illustrated by the process flow shown in FIG. 3. The rejection is pushed to the software application, then back to the company once processed. This may queue the company to release the job posting again in the event it was removed pending the conditional offer. From there, the process of FIG. 1 may restart, where the job posting is released again to the entire network, and the process repeats itself.

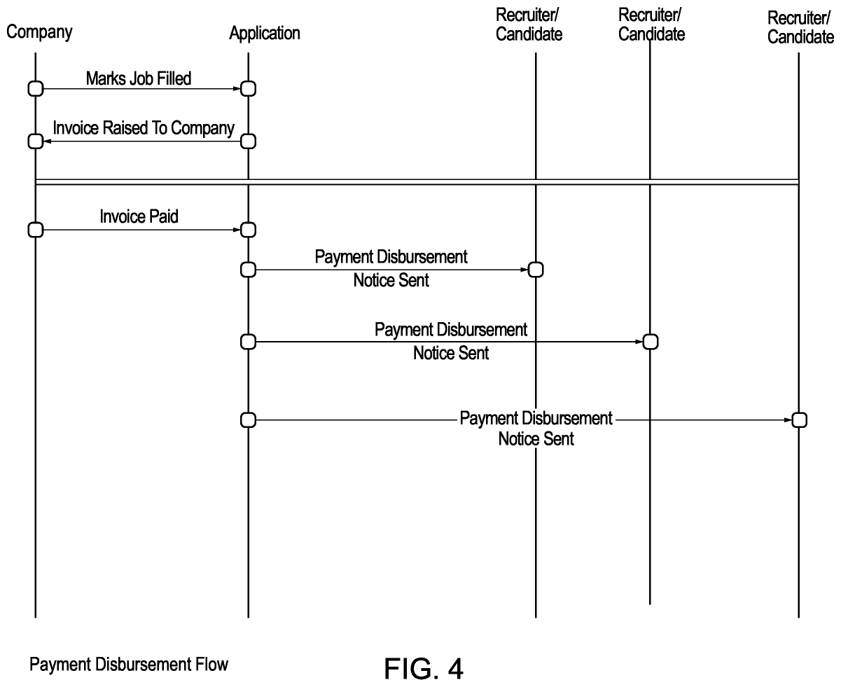

Turning now to FIG. 4, it is an object of the present invention to dramatically enlarge a pool of qualified candidates by crowdsourcing job postings. This happens in part by incentivizing an entire community based on industry or geography, for example, to bring qualified candidates to the attention of an employer utilizing a system as described herein by paying referral fees. To achieve this, a software application of the present disclosure may be configured to process payments to recruiters once positions are marked as filled. This is done by prompting the recruiter to use the system to create an invoice to be pushed up to the company for payment and allow for receipt notifications to be pushed back down to the recruiter, and payment to be disbursed in accordance with the methods that will be understood by one of ordinary skill in payment applications, such as wire release or automated clearinghouse (ACH) payments.

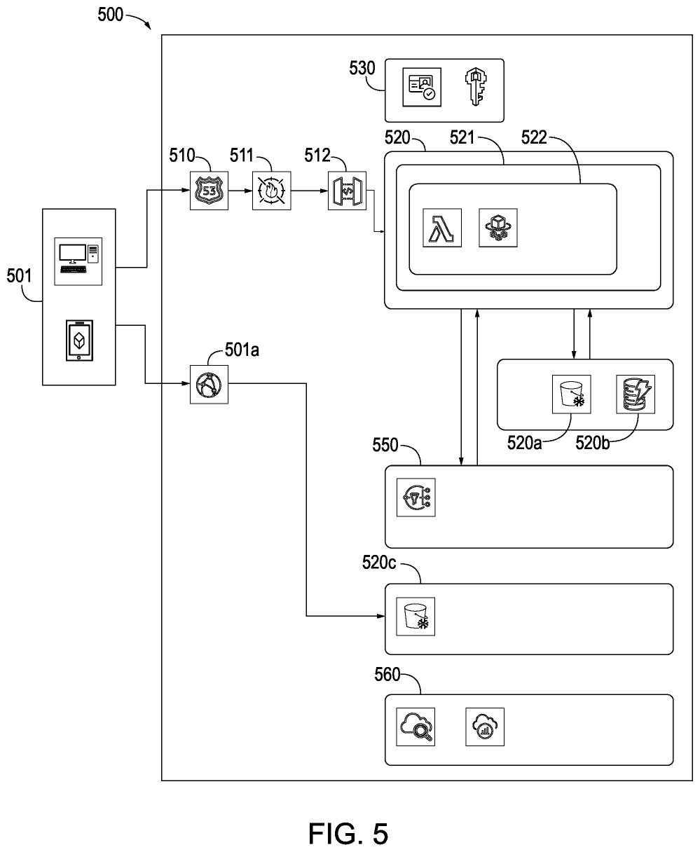

To enable the processes illustrated in FIGS. 1-4, users may access a system 500, an example of which is shown in FIG. 5, using secure login to a provided website using an available web browser, or by interfacing with the system over an application programming interface (API) 512 via smartphone, laptop or the like 501. Using this methodology, web servers may be accessed, where a software application according to the present invention is tangibly stored on a non-transitory computer readable medium 520, the software application comprising instructions which when executed by a connected processor cause the processor to carry out the various functions described above as illustrated in FIGS. 1-4.

Federated identity features 530 may be provided for user authentication before user instructions are enabled by the system. User interfaces such as graphical user interfaces (GUIs) may be presented on a connected user computer or smartphone 501 to enable the viewing of postings, pushing of candidate information, acceptance or rejection of offers, interview scheduling, etc., as described with reference to FIGS. 1-4 above. Commercially available cloud web service providers may be utilized to house applications and process data according to the software instructions. These and other features will be understood by one of ordinary skill in that art.

An exemplary system architecture according to the present disclosure is illustrated in FIG. 5. A secure central server allows for user identity and access management, wherein authenticated users of the system may then log in and push notifications out to the community. A scalable Domain Name System (DNS) web service 510 is provided to perform domain registration, DNS routing, and health checking, or combinations thereof. A web application firewall 511 is provided in order to enable the system administrator to set the desired security rules to enable access to an API 512 so that information may be input for processing according to instructions tangibly stored on a non-transitory computer readable medium 520, which when executed by a processor cause the processor to the input information to the user community. In an exemplary embodiment, computing occurs on a virtual private cloud (VPC) 521, which eliminates the need for the use of local equipment.

A private subnet may be provided on a VPC wherein execution requests may be made and instructions executed accordingly in a secure environment. A serverless computing engine may be provided on a subnet 522 that allows for application building without the need for server management. Push notifications may then be managed using a notification service 550 in accordance with the computing instructions contained in the execution requests so community users may be notified of new candidate information, job postings, etc. A means for object-based data storage 520a may be provided on a subnet, in communication with a dynamic database 520b to enable continuous updating of information pushed to the user community.

Content may be distributed from a provided mobile software application stored on any compatible device (e.g., smartphone, tablet) 501 over a provided content delivery network (CDN) 501a for object-based storage 520c. Real-time logs, metrics and event data may be collected and stored for viewing using a suitable logging means 560 of requests traveling through a system of the present disclosure and visual data filtering of video content created by users of the system. For example, a video resume may be created, then analyzed and debugged before being made available to viewers. Viewers may then select discrete video elements for viewing and sharing with other users within an organization, for example. The utility of these and other features of the systems and methods described herein will be apparent to one of ordinary skill in the art.

What is claimed:

1. A system for distributing employment-related content to an authenticated user community, the system comprising:
an identity access management (IAM) system;
a computing device for inputting data into the system, the data comprising job descriptions, resume information and combinations thereof; and
an application programming interface (API) configured to enable communication between the computing device and a software application tangibly stored on a non-transitory computer readable medium comprising instructions which when executed by a connected processor cause the processor to store the data and send push notifications comprising the data to the user community.

2. The system of claim 1, further comprising a domain name system (DNS) configured for domain registration, DNS routing, health checking and combinations thereof.

3. The system of claim 1, further comprising a web application firewall configured to allow, block, or monitor web requests based on defined conditions.

4. The system of claim 1, wherein the software application is stored on a virtual private cloud (VPC).

5. The system of claim 1, wherein the software application is in network communication with an object storage medium in further communication with a database, wherein the object storage medium is configured to allow continuous updates and the updates are stored within the database as they occur.

6. A system according to claim 1, wherein the resume information is video resume information.

7. A system according to claim 6, wherein software application is configured to allow a user to view the video resume information or discrete portions thereof.

8. A system according to claim 6, wherein software application is configured to allow a user to share the video resume information or discrete portions thereof with other users.

9. A system according to claim 1, wherein the computing device for inputting data into the system comprises a mobile software application configured to allow the data to be input by a user via a graphical user interface (GUI).

10. A process for crowdsourcing employment recruiting, the process comprising the steps of:
pushing a job notification using a system according to claim 1 a recruiter, a job candidate, or both;
pushing resume information for the job candidate to a user who posted the job notification; and
pushing an interview request notification to the job candidate, wherein the job candidate may accept and schedule, or decline, the requested interview.

11. The process of claim 10, further comprising pushing a conditional job offer notification to the job candidate to the recruiter, the job candidate, or both, wherein the system is configured to allow the job candidate to accept or reject the conditional offer via push notification.

12. The process of claim 11, further comprising pushing a reference request notification to the recruiter, the job candidate, or both, wherein the job candidate or recruiter may in turn push reference nominations in response to the reference request, wherein a user who pushed the reference request notification may in turn push a request to each reference nominated directly to the reference.

13. The process of claim 12, further comprising pushing a background check request notification to the recruiter, the job candidate, or both, wherein the job candidate or recruiter may in turn push reference background check results to a user who pushed the background check request notification.

14. The process of claim 10, further comprising pushing the job notification to a user community if the job candidate rejects the conditional job offer.
